(19) United States
(12) Patent Application Publication
(10) Pub. No.: US 2004/0263428 A1
(43) Pub. Date: Dec. 30, 2004

(54) Electronic apparatus and display control method

(75) Inventor: Hidehiko Sudo, Ome-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/826,360

(22) Filed: Apr. 19, 2004

(30) Foreign Application Priority Data
Jun. 30, 2003 (JP) 2003-187024

(51) Int. Cl. G09G 5/00

(52) U.S. Cl. 345/7; 345/4; 345/9

(57) ABSTRACT

A CPU receives, from a changeover switch, a setting as to whether a subject is imaged in portrait orientation or landscape orientation. Based on the setting, the CPU determines on which position of an image of the subject obtained by a CCD camera and stored in a VRAM an icon and the like are to be superposed. Further, the CPU generates a composite image in which the icon is superposed on the determined position of the subject image, and displays the composite image on an LCD with a touch panel. Further, if the touch panel is pressed, the CPU judges whether the pressed position is the determined position on which the icon is superposed. If it is the icon position, the CPU performs processing corresponding to the icon.

### CROSS-REFERENCE TO RELATED APPLICATIONS

This application is based upon and claims the benefit of priority from prior Japanese Patent Application No. 2003-187024, filed Jun. 30, 2003, the entire contents of which are incorporated herein by reference.

### BACKGROUND OF THE INVENTION

1. Field of the Invention

The present invention relates to an electronic apparatus, such as a digital camera and a personal digital assistants (PDAs) equipped with a camera, and a display control method of the apparatus.

2. Description of the Related Art

Techniques of manufacturing image pickup devices, such as charge coupled device (CCD), have been dramatically improving recently. Such devices have been so miniaturized that a camera which can obtain images of high definition can be mounted on a PDA fit in the palm of a hand. Generally, a liquid crystal display (LCD) with a touch panel is provided on PDAs of this kind, thus it is possible to display subject images obtained by the camera on the LCD in real time. Therefore, the user can decide the timing of performing a release operation while viewing the subject images displayed on the LCD.

Generally, each image pickup device such as CCD has a rectangular imaging region, and an LCD also has a rectangular display region which has almost the same shape as that of the imaging region of the image pickup device. Therefore, the user turns the camera-equipped PDA by 90 degrees, in the case of obtaining vertically oriented subject images (portrait subject images) from the state of obtaining horizontally oriented subject images (landscape subject images), and vice versa. In such a case, if any text information is displayed, superposed on the subject images obtained by the camera, on the LCD, the orientation of the text information is also desirably turned by 90 degrees. For example, in an image display apparatus disclosed in Jpn. Pat. Appln. KOKAI Publication No. 2000-98990 (FIG. 11), the position of the image display device is sensed, and the orientation of text to be superposed is controlled on the basis of the sensing result.

In PDAs provided with an LCD with a touch panel, software-based buttons are used as user interface, in addition to actual buttons mounted on the housing. As the software-based buttons, icons are displayed on the LCD. When the display position of an icon is pressed by a pen or the like, the touch panel senses the pressing, and processing corresponding to the icon is performed.

In consideration of ease-of-use of the user interface, icons are desirably controlled to be always displayed in, for example, a lower right portion on the display as viewed from the user, in both cases where the camera-equipped PDA is vertically oriented and horizontally oriented.

However, in the image display apparatus disclosed in Jpn. Pat. Appln. No. 10-266525, although the orientation of the text is optimized according to the orientation of the apparatus, the actual display position of the text remains unchanged, and thus it appears to the user that the position of the text has been changed. Even if this technique is applied to display of icons, it is impossible to keep the usability of the apparatus to the user constant. Further, in the apparatus of 10-266525, it is not considered at all that a region to be monitored to sense selection of icons is varied together with the display position of the icons, if the display position is variable.

### BRIEF SUMMARY OF THE INVENTION

According to an embodiment of the present invention, an electronic apparatus comprises a display unit configured to display a display image and a user interface image, a setting unit configured to set a position of the display unit to be positioned to one of a first position and a second position, and an arrangement control unit configured to control arrangement of the user interface image to be displayed on the display unit based on a setting result of the setting unit.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram illustrating a structure concerning display control in an electronic apparatus according to a first embodiment of the present invention.

FIG. 2 is an external view illustrating a use of the electronic apparatus of the first embodiment, if a subject is imaged as a horizontally oriented image.

FIG. 3 is an external view illustrating a use of the electronic apparatus of the first embodiment, if a subject is imaged as a vertically oriented image.

FIG. 4 is a diagram illustrating an example of user interface image data stored in a memory of a CPU in the first embodiment.

FIG. 5 is a flow chart for explaining an operation procedure for display control performed by the electronic apparatus of the first embodiment.

FIG. 6 is a diagram illustrating a structure concerning display control in an electronic apparatus according to a second embodiment of the present invention.

FIG. 7 is a flow chart for explaining an operation procedure for display control performed by the electronic apparatus of the second embodiment.

### DETAILED DESCRIPTION OF THE INVENTION

Embodiments of the present will now be explained with reference to drawings.

### FIRST EMBODIMENT

First, a first embodiment of the present invention is explained.

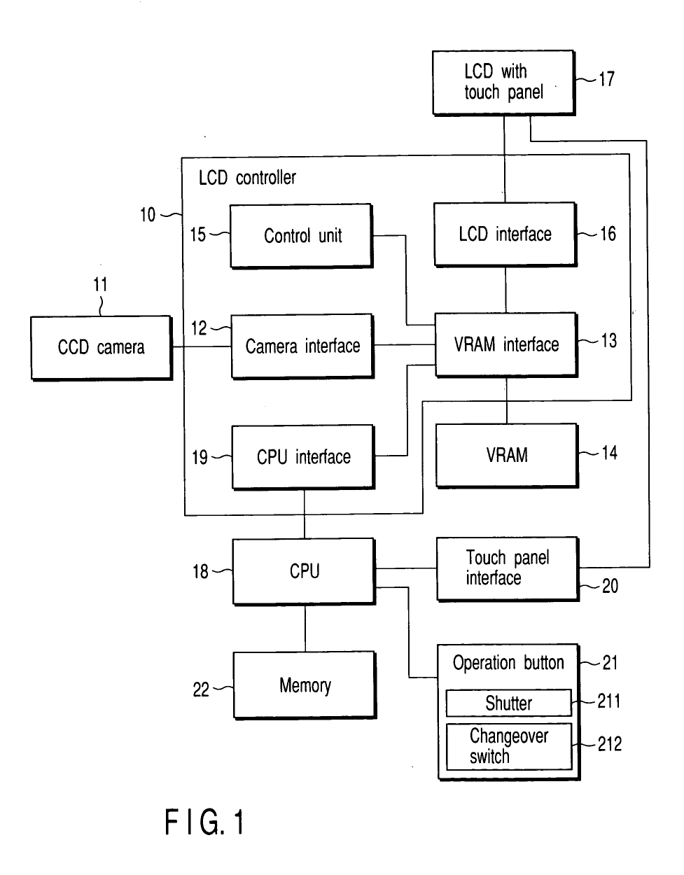

FIG. 1 is a diagram illustrating a structure concerning display control in an electronic apparatus according to a first embodiment of the present invention.

The electronic apparatus is a so-called PDA which is battery-powered. As shown in FIG. 1, the electronic apparatus comprises a CCD camera 11, an LCD controller 10, a VRAM 14, an LCD 17 with a touch panel, a CPU 18, a touch panel interface 20, operation buttons 21 and a memory 22. The LCD controller 10 comprises a control unit 15, a camera interface 12, a VRAM interface 13, an LCD interface 16 and a CPU interface 19. The VRAM 14 may be included in the LCD controller 10. Further, all the sections in the LCD controller 10 are controlled by the control unit 15.

Image data of a subject image obtained by the CCD camera 11 is read by the camera interface 12, and transmitted from the camera interface 12 to the VRAM interface 13. The VRAM interface 13 stores the image data of the subject image in the VRAM 14. In response to an instruction from the control unit 15, the image data stored in the VRAM 14 is read by the VRAM interface 13, and transmitted from the VRAM interface 13 to the LCD interface 16. The LCD interface 16 performs control to display the image data on the LCD 17 with the touch panel. Thereby, the subject image picked up by the CCD camera 11 is displayed on the touch-panel-equipped LCD 17, thus the user can use the touch-panel-equipped LCD 17 as a viewfinder.

In the meantime, the CPU 18 performs display control to display user interface images, such as icons, superposed on the subject image, in a proper position of the touch-panel-equipped LCD 17. Therefore, the CPU 18 transmits user interface image data stored in the memory 22 to the VRAM interface 13 via the CPU interface 19, together with an instruction indicating a position of the subject image in the VRAM 14, on which the user interface image data is to be superposed. Thereby, the subject image and icon image or the like are superposed in the VRAM 14, and the user views the superposed image on the LCD 17.

Every time the touch-panel-equipped LCD 17 is pressed by a pen, etc., the touch panel interface 20 notifies the CPU 18 of the pressed position. The CPU 18 which has been notified thereof judges whether or not the pressed position is a position in which any icon image is displayed. If any icon image is displayed in the position, the CPU 18 performs processing corresponding to the icon image. This structure enables function of user interface using user interface images displayed on the subject image.

Further, the CPU 18 is connected with the operation buttons 21. When any operation is notified from the operation buttons 21 to the CPU 18, the CPU 18 performs processing corresponding to the notified operation. For example, when the CPU 18 is notified of pressing of a shutter 211 being one of the operation buttons 21, the CPU 18 records the subject image being displayed on the LCD 17, that is, image data being stored in the VRAM 14, in a detachable card-shaped storage medium (not shown) or the like. The operation buttons 21 also include a changeover switch for setting whether the subject is imaged in portrait (vertical) orientation or landscape (horizontal) orientation. When the CPU 18 is notified of an operation of the changeover switch 21, the CPU 18 changes arrangement of icon images and the like. A switch control of arrangement of the icon images and the like is detailed below.

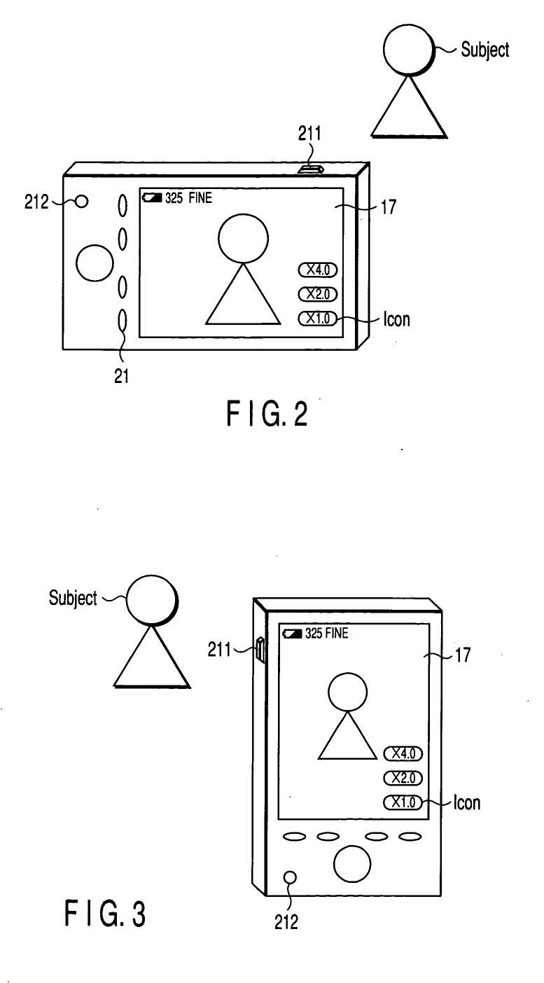

FIG. 2 is an external view illustrating a use of the electronic apparatus if the subject is imaged in landscape orientation. In this case, the user holds the electronic apparatus, such that the touch-panel-equipped LCD 17 used as a viewfinder is disposed in landscape orientation. In this case, as the user interface images, indicators indicating the battery remaining amount, the number of recordable images and the image quality are displayed in an upper left portion of the subject image. Further, as the user interface images, icons for adjusting the zoom magnification ranging from 1 to 4 are displayed in a lower right portion of the subject image.

Assuming that in this state the user intends to image the subject in portrait orientation next. In this case, the user presses the changeover switch 212, and changes the orientation of the electronic apparatus such that the touch-panel-equipped LCD 17 is disposed in portrait orientation. FIG. 3 is an external view illustrating a use of the electronic apparatus in this case.

As shown in FIG. 3, even after the user changes the orientation of the electronic apparatus such that the LCD 17 is disposed in portrait orientation, the indicators indicating the battery remaining amount, the number of recordable images and the image quality are still displayed in the upper left portion of the subject image, as the user interface images. Further, the icons for adjusting the zoom magnification ranging from 1 to 4 are still displayed in the lower right portion of the subject image. Specifically, it is possible to maintain the usability of the electronic apparatus constant by pressing the changeover switch 212, in both cases of holding the electronic apparatus such that the LCD 17 is disposed in portrait direction and landscape orientation.

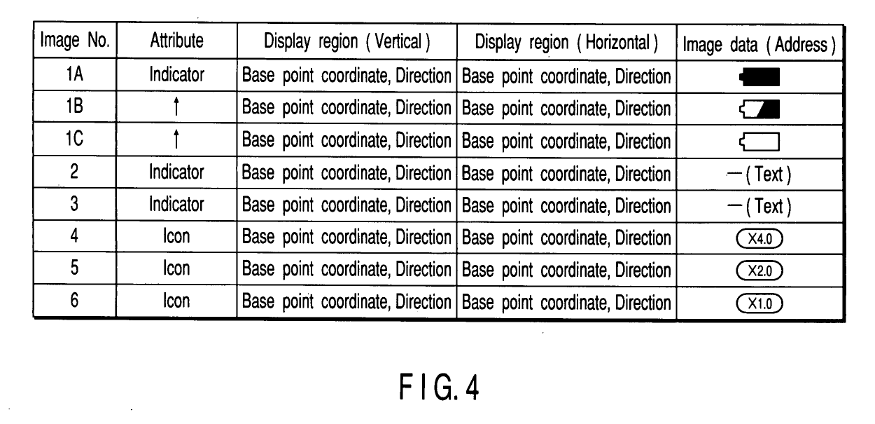

FIG. 4 is a diagram illustrating an example of user interface image data stored in the memory 22.

As shown in FIG. 4, the user interface image data is stored as a table in the memory 22. Data items of their image numbers, attributes, display region (vertical) and display region (horizontal) are also stored in the memory 22.

Among the image numbers, two-digit numbers each comprising the same number and an alphabet form an image group. The alphabet of each two-digit number serves as a section number of the group. One image is selected and used from images of the same group. For example, with respect to the indicator indicating the battery remaining amount (1A-1C), the image 1A is selected and used if the battery is in a fully charged condition, the image 1B if the battery is in a medium condition, and the image 1C if the battery is in a weak condition.

The item “attribute” indicates whether the image is displayed as indicator or icon. When the touch panel interface 20 notifies the CPU 18 of pressing in a display region described below, the CPU 18 judges, on the basis of the attribute, whether it is necessary to perform any processing. More specifically, if the CPU 18 is notified of pressing of a region displaying an icon, the CPU 18 performs processing corresponding to the icon.

The items “display region (vertical)” and “display region (horizontal)” hold data indicating the base point coordinates (for example, an upper left position) of image data, and the direction in which the image is drawn from the base point coordinates. The item “display region (vertical)” holds data associated with the case of imaging the subject in portrait orientation, and the item “display region (horizontal)” holds data associated with the case of imaging the subject in landscape orientation. (One of the items is selected by pressing the changeover switch 212.)

The item “image data” indicates the storing position (address) in the memory 22 of the image data which is to be displayed in the position indicated by the item “display region (vertical)” or “display region (horizontal)”. As the image whose item “image data” is blank, text information is displayed instead of image. For example, as the indicator (image No. 3) which indicates the image quality, text information such as “FINE”, “NORMAL” and “BASIC” is displayed.

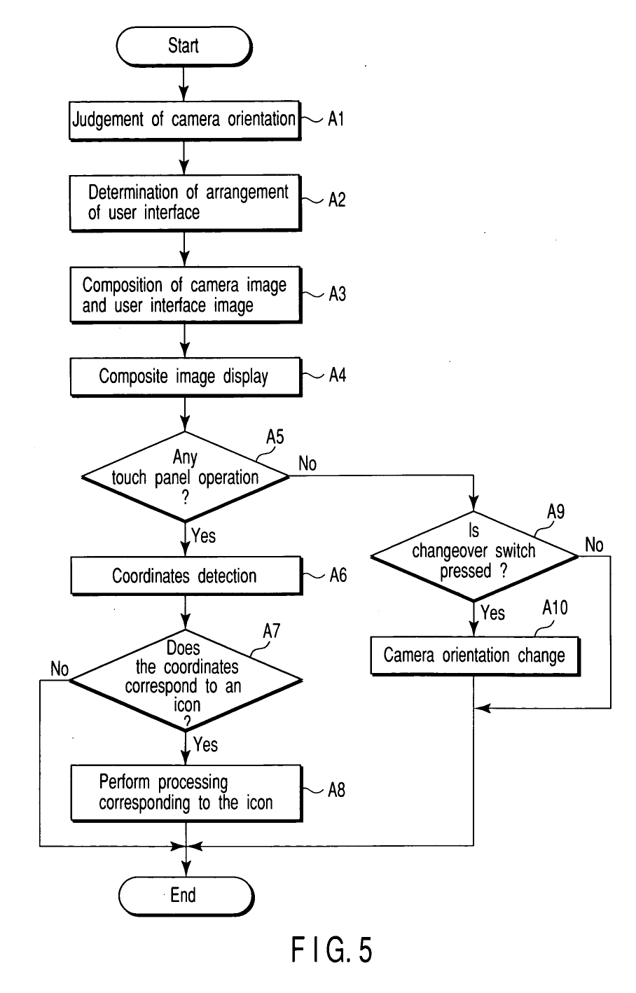

Next, with reference to FIG. 5, explained is an operation procedure of display control performed by the electronic apparatus of the first embodiment.

First, the CPU 18 judges the orientation of the electronic apparatus (camera) on the basis of the state of the changeover switch 212 (step A1). Based on the judgment result, the CPU 18 determines arrangement of the user interface (step A2). Next, based on the determined arrangement, the CPU 18 carries out and controls superposition of the subject image (camera image) and the interface image (step A3), and renders the composite image on display (step A4).

If the touch panel is operated after display of the composite image (YES of step A5), the CPU 18 detects coordinates of the operated position (step A6), and judges whether the coordinates correspond to a position in which an icon is displayed (step A7). If the coordinates correspond to a position displaying an icon (YES of step A7), the CPU 18 performs processing corresponding to the icon (step A8).

In the meantime, if the touch panel is not operated (NO of step A5) and the changeover switch is pressed down (YES of step A9), the CPU 18 recognizes that the orientation of the camera has been changed (step A10).

As described above, according to the electronic apparatus of the first embodiment, in both cases of imaging the subject in portrait orientation and in landscape orientation, the user interface images are displayed in relatively fixed positions as viewed from the user. Further, regions to be monitored for judging presence/absence of operation of the user interface are changed in connection with the change in actual display positions of the user interface images.

### SECOND EMBODIMENT

Next, a second embodiment of the present invention is explained.

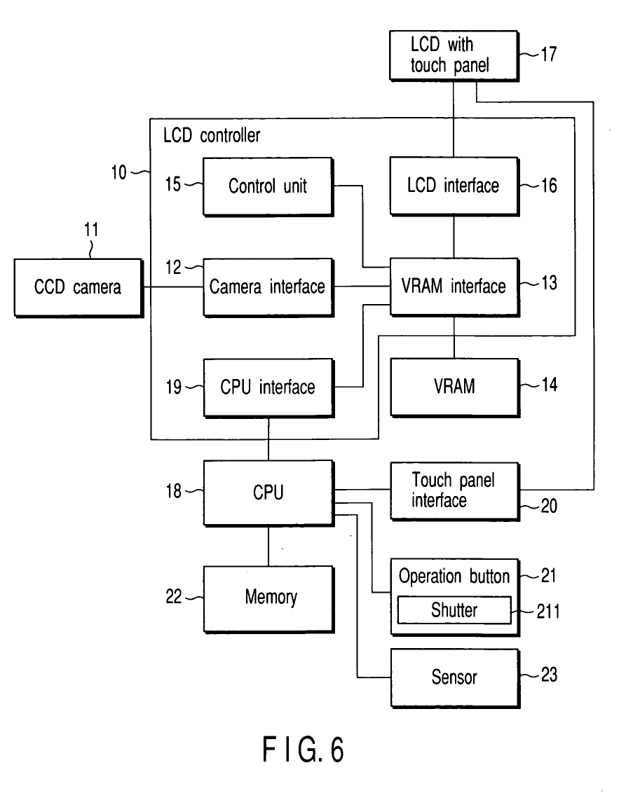

FIG. 6 is a diagram illustrating a structure concerning display control in an electronic apparatus according to the second embodiment of the present invention.

The electronic apparatus of the second embodiment is different from that of the first embodiment, in that a sensor 23 is newly provided and the changeover switch 212 is removed. The sensor 23 is, for example, an acceleration sensor which can sense the disposed state of the electronic apparatus by detecting the direction of gravity. Specifically, in the electronic apparatus of the second embodiment, control to change the arrangement of icon images and the like is automatically performed based on the detection result of the sensor 23, not on an explicit instruction by the user. As a method of detecting the direction of gravity, adopted is a method detecting the direction of heat conduction, for example.

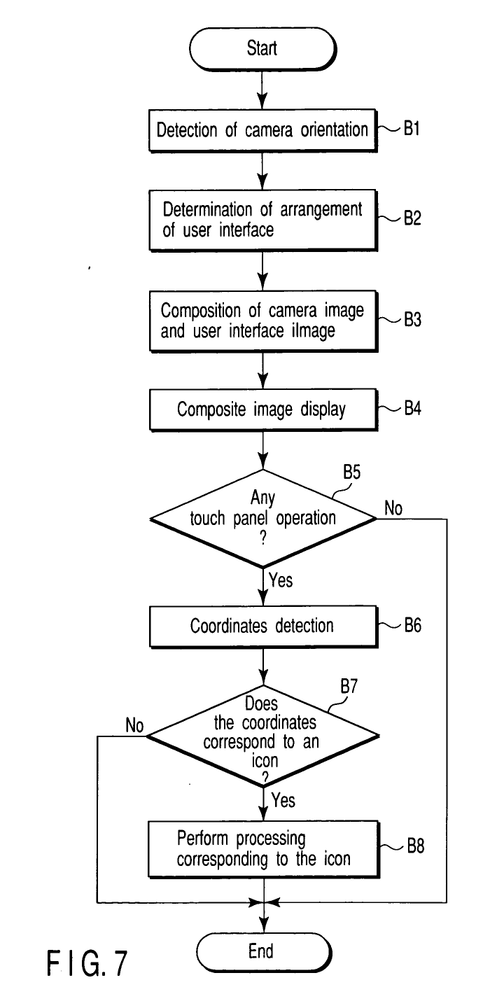

FIG. 7 is a flow chart for explaining an operation procedure of display control performed by the electronic apparatus of the second embodiment.

First, a CPU 18 judges the orientation of the electronic apparatus (camera) on the basis of result of detection by the sensor 23 (step B1). Based on the judgment result, the CPU 18 determines arrangement of the user interface (step B2). Next, based on the determined arrangement, the CPU 18 carries out and controls superposition of the subject image (camera image) and the interface image (step B3), and renders the composite image on display (step B4).

If the touch panel is operated after display of the composite image (YES of step B5), the CPU 18 detects coordinates of the operated position (step B6), and judges whether the coordinates correspond to a position in which an icon is displayed (step B7). If the coordinates correspond to a position displaying an icon (YES of step B7), the CPU 18 performs processing corresponding to the icon (step B8).

As described above, also according to the electronic apparatus of the second embodiment, in both cases of imaging the subject in portrait orientation and in landscape orientation, the user interface images are displayed in relatively fixed positions as viewed from the user. Further, regions to be monitored for judging presence/absence of operation of the user interface are changed in connection with the change in actual display positions of the user interface images.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a display unit configured to display a user interface image;
a setting unit configured to set a position of the display unit to be positioned to one of a first position and a second position; and
an arrangement control unit configured to control arrangement of the user interface image to be displayed on the display unit based on a setting result of the setting unit.

2. The electronic apparatus according to claim 1, wherein the second position is a position to which the display unit is turned from the first position.

3. An electronic apparatus comprising:
an imaging unit configured to image a subject;
a display unit configured to display a composite image obtained by superposing a subject image imaged by the imaging unit and a user interface image;
a setting unit configured to set a position of the display unit to be viewed to one of a first position and a second position; and
an arrangement control unit configured to control arrangement of the user interface image in the composite image to be displayed on the display unit based on a setting result of the setting unit.

4. The electronic apparatus according to claim 3, wherein the second position is a position to which the display unit is turned by almost a right angle from the first position with a normal of the display unit used as an axis.

5. The electronic apparatus according to claim 3, further comprising:
a touch-type input unit, an input surface of which is superposed on a display surface of the display unit; and
an input control unit configured to control an input from the input unit based on an arrangement result of the arrangement control unit.

6. An electronic apparatus comprising:
an imaging unit configured to image an subject;
an display unit configured to display a composite image obtained by superposing a subject image imaged by the imaging unit and a user interface image;
a detection unit configured to detect a position of the display unit to be viewed to one of a first position and a second position; and
an arrangement control unit configured to control arrangement of the user interface image in the composite image to be displayed on the display unit based on a detection result of the detection unit.

7. The electronic apparatus according to claim 6, wherein the second position is a position to which the display unit is turned by almost a right angle from the first position with an normal of the display unit used as an axis.

8. The electronic apparatus according to claim 6, further comprising:
a touch-type input unit, an input surface of which is superposed on a display surface of the display unit; and
an input control unit configured to control an input from the input unit based on an arrangement result of the arrangement control unit.

9. The electronic apparatus according to claim 6, wherein the detection unit is a sensor which detects a direction of gravity.

10. The electronic apparatus according to claim 6, wherein the detection unit is a sensor which detects a direction of heat conduction.

11. A display control method comprising:
imaging a subject;
displaying a composite image obtained by superposing an image of the imaged subject and a user interface image;
determining whether the composite image is to be viewed in a first orientation or a second orientation; and
controlling arrangement of the user interface image in the composite image to be displayed based on a result of the determining.

12. The display control method according to claim 11, wherein the second orientation is an orientation to which the display surface is turned by almost a right angle from the first orientation with a normal line thereof used as an axis.

13. The display control method according to claim 11, wherein the determining is performed based on a state of a switch or an operation state of the switch.

14. The display control method according to claim 11, wherein the determining is performed based on an output signal of a sensor.
